(19) United States
(12) Patent Application Publication
(10) Pub. No.: US 2026/0267618 A1
(43) Pub. Date: Sep. 10, 2026

(54) BOOSTING LLM CODE GENERATION VIA PREFERENCE-GUIDED REFINEMENT

(71) Applicant: Adobe Inc., San Jose, CA (US)

(72) Inventors: Xiang Chen, Palo Alto, CA (US); Tung Mai, San Jose, CA (US); Tong Yu, San Jose, CA (US); Saayan Mitra, San Jose, CA (US); Ryan A. Rossi, Santa Clara, CA (US); Leitian Tao, Madison, WI (US)

(21) Appl. No.: 19/069,721

(22) Filed: Mar. 4, 2025

(51) Int. Cl. G06F 8/35

(52) U.S. Cl. CPC G06F 8/35

(57) ABSTRACT

The present disclosure is directed toward systems, methods, and non-transitory computer readable media that finetune large language models for code generation based on code execution results using preference-guided learning. For example, the disclosed systems utilize a large language model to generate a set of code responses from a natural language query, wherein the set of code responses correspond to code. Furthermore, the disclosed systems compare the set of code responses to a ground truth code response to generate a set of correct code responses and a set of incorrect code responses. The disclosed systems generate a preference dataset from preference pairs selected from the set of correct code responses and the set of incorrect code responses. In addition, the disclosed systems finetune the large language model by modifying parameters of the large language model to reduce incorrect code responses according to a loss function based on the preference dataset.

### BACKGROUND

Advancements in computing devices and digital content systems have led to innovative developments in large language models (LLMs) that process and respond to natural language input. For example, many entities use large language models to perform a wide array of tasks such as generating detailed explanations, synthesizing textual content, extracting insights from documents, and supporting complex decision-making processes. The ability of large language models to generalize across diverse topics stems from pre-training on extensive datasets that include a wide range of natural language and programming language sources. Based on these pre-training datasets, many large language models exhibit an understanding of syntax, semantics, and context to produce contextually relevant outputs. Despite these capabilities, when adapting large language models to highly specialized domains like code generation, existing training systems face challenges in accuracy and computational efficiency, particularly when utilizing limited datasets.

For example, existing systems have a number of shortcomings in terms of computational efficiency and accuracy when training large language models for code generation. For example, while many closed-source large language models generate responses for a variety of queries, these closed-source large language models are highly resource-intensive. Many closed-source large language models also impose restrictions on finetuning for specific code generation tasks. Moreover, pre-trained open-source large language models frequently underperform on task specific datasets and code generation tasks without additional finetuning. The training approaches of existing systems typically use supervised fine-tuning to improve performance of the underperforming open-source large language models, though supervised fine-tuning yields only an incremental improvement. Because supervised fine-tuning relies solely on correct code examples, existing systems restrict the ability of open-sourced large language models to learn from mistakes during training, reducing adaptability to diverse programming challenges.

Furthermore, existing systems are inaccurate when finetuning large language models for code generation. In particular, unlike general natural language processing tasks, code generation requires not only syntactical correctness, but also an accurate response based on both logical and domain specific nuances that is not addressed by existing systems. For example, because the training process of many existing systems focuses exclusively on the syntactical correctness of the provided example code while focusing on positive samples, the existing systems restrict large language models from learning from their own mistakes. To illustrate, during the finetuning process of existing systems, if the large language model only predicts wrongly in the final token in a code snippet, the overall probability for the code snippet might still be considered high (when the preceding tokens are correct). However, with existing systems, in some cases this single incorrect token renders the entire code nonfunctional or introduces subtle bugs, significantly affecting execution accuracy despite a high likelihood score. This reliance of existing models on only correct examples limits the capacity of the existing models to identify and recover from errors, reducing the ability of existing models to accurately generate code for complex and/or nuanced coding tasks.

### SUMMARY

One or more embodiments provide benefits and/or solve one or more of the foregoing or other problems in the art with systems, methods, and non-transitory computer readable storage media to finetune large language models for code generation based on code execution results using preference-guided learning. For example, the disclosed systems generate a set of code responses including code based on a natural language query to a large language model. Furthermore, in some embodiments, the disclosed systems sort the set of code responses into correct samples and incorrect samples by comparing an executed result of a ground truth code response to executed results of the set of code responses and labeling responses matching the ground truth result as correct samples and those that do not match the ground truth result as incorrect samples. The disclosed systems generate preference pairs by combining pairs of code responses from the correct samples and the incorrect samples (e.g., by random sampling with replacement). The disclosed systems use the preference pairs to finetune the large language model by modifying parameters of the large language model to reduce the likelihood of the large language model producing incorrect code responses. In some embodiments, the disclosed systems utilize a dual-loss function that integrates direct preference optimization and supervised fine tuning to finetune the large language model.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a preference-guided code generation system in accordance with one or more embodiments;

FIG. 2 illustrates an example overview of the preference-guided code generation system finetuning a large language model in accordance with one or more embodiments;

FIG. 3 illustrates an example of the preference-guided code generation system causing a large language model to generate a set of code responses from an initialization dataset in accordance with one or more embodiments;

FIG. 4 illustrates an example of the preference-guided code generation system generating a set of correct code responses and a set of incorrect code responses from a set of code responses in accordance with one or more embodiments;

FIG. 5 illustrates an example of the preference-guided code generation system generating a preference dataset to finetune a large language model in accordance with one or more embodiments;

FIG. 6 illustrates an example of the preference-guided code generation system utilizing a dual-loss function to finetune a large language model in accordance with one or more embodiments;

FIG. 7 illustrates a graph including a quantitative example of the effect of utilizing a dual-loss function on code response likelihood when finetuning a large language model in accordance with one or more embodiments;

FIG. 8 illustrates quantitative results of ablation studies for the preference-guided code generation system corresponding to negative samples, initialization dataset size, and ground truth code responses in accordance with one or more embodiments;

FIG. 9 illustrates a diagram of an example architecture of the preference-guided code generation system in accordance with one or more embodiments;

FIG. 10 illustrates a flowchart of a series of acts for finetuning a large language model by modifying parameters based on a preference dataset in accordance with one or more embodiments; and

FIG. 11 illustrates a block diagram of an example computing device in accordance with one or more embodiments.

### DETAILED DESCRIPTION

This disclosure describes one or more embodiments of a preference-guided code generation system that finetunes large language models for code generation using preference-guided learning based on code execution results. For example, the preference-guided code generation system utilizes pairs of correct samples and incorrect samples of code to finetune a large language model. Specifically, the preference-guided code generation system utilizes a large language model to generate a set of code responses including code based on a natural language query. Furthermore, in some embodiments, the preference-guided code generation system determines a set of correct code responses and determines a set of incorrect code responses based on the set of code responses in relation to a ground truth code response. In certain cases, the preference-guided code generation system generates preference pairs by combining pairs of correct code responses with incorrect code responses. The preference-guided code generation system uses the preference pairs to finetune the large language model to reduce the likelihood of generating incorrect code responses via the large language model.

More specifically, in one or more embodiments, the preference-guided code generation system causes a large language model to generate code responses based on a set of natural language queries. For example, the preference-guided code generation system provides an initialization dataset that includes natural language queries (e.g., from cross-domain sources based on a diverse representation of coding problems and solutions) and the corresponding ground truth code solutions to a large language model. By providing the initialization dataset, the preference-guided code generation system prompts the large language model to generate a set of code responses to perform specific tasks. At each iteration of training, the preference-guided code generation system causes the large language model to generate multiple responses for a plurality of natural language queries of the training dataset. Embodiments of the preference-guided code generation system support a variety of use cases, including data querying (e.g., generating SQL statements for database interaction) and data science workflows (e.g., producing Python code that utilizes libraries such as NumPy for numerical computations or data analysis).

In one or more embodiments, the preference-guided code generation system evaluates the set of code responses to select correct code responses and incorrect code responses. In some cases, the preference-guided code generation system generates the correct code responses by comparing executed results of the code responses to ground truth executed results derived from the associated ground truth code response. In some cases, the preference-guided code generation system generates the correct code responses by selecting the executable code responses of the set of code responses. Similarly, the preference-guided code generation system selects the incorrect code responses that fail to meet the desired functional requirements or objectives of the set of natural language queries. In some cases, the preference-guided code generation system selects the incorrect code responses by comparing the executed results of the code responses to the ground truth executed results derived from the associated ground truth code response. In some cases, the preference-guided code generation system selects the incorrect code responses by selecting the non-executable code responses of the set of code responses.

In certain embodiments, the preference-guided code generation system generates a preference dataset from the set of code responses. For example, the preference-guided code generation system creates the preference dataset as a set of preference pairs randomly selected from the correct code responses and the incorrect code responses. In certain embodiments, the preference-guided code generation system generates the preference dataset with a specified number of preference pairs. In some cases, if the generated number of correct code responses or the generated number of incorrect code responses is insufficient to fill the specified number of preference pairs, the preference-guided code generation system 106 generates the preference dataset by sampling with replacement from the correct code responses and/or the incorrect code responses.

In one or more embodiments, the preference-guided code generation system refines the large language model utilizing preference-driven optimization. For example, the preference-guided code generation system utilizes a dual-loss function that integrates direct preference optimization (DPO) balanced with supervised fine-tuning (SFT). In some cases, the preference-guided code generation system utilizes a first loss term corresponding to direct preference optimization to favor correct code responses over incorrect code responses in code responses generated by the large language model based on the preference pairs. In some cases, the preference-guided code generation system utilizes a second loss term corresponding to supervised fine tuning to increase a likelihood of the large language model generating correct code responses based on the set of correct code responses in the preference pairs. Through the use of a dual-loss function, embodiments of the preference-guided code generation system not only rank the correct code responses higher but also increase their generation probability.

As suggested above, embodiments of the preference-guided code generation system overcome disadvantages inherent in existing systems. For example, the preference-guided code generation system improves upon the computational efficiency of existing systems using preference-guided optimization. Rather than large external datasets or larger auxiliary model feedback of existing systems, embodiments of the preference-guided code generation system utilize a dual-loss mechanism where execution correctness is a key indicator of preference. To illustrate, using iterative refinement guided using self-generated preference pairs that incorporate both correct code solutions and common mistakes of large language models, the preference-guided code generation system more efficiently updates the large language models parameters. In this way, embodiments of the preference-guided code generation system enable continuous improvements for large language models using limited initial data (e.g., a few hundred samples). In addition, the preference-guided code generation system uses a training pipeline that bypasses the standalone supervised fine-tuning stage typically required by existing systems before the preference optimization phase, thereby further streamlining the training process.

Furthermore, the preference-guided code generation system improves upon the accuracy of code generation as compared to existing systems. For example, even with limited input data, the preference-guided code generation system achieves significant improvements in code quality using iterative refinement with direct preference optimization based on code execution results. Unlike conventional supervised fine-tuning approaches of existing systems, the preference-guided code generation system employs iterative, preference-guided refinement to maximize the likelihood of generating accurate code. Unlike existing systems that lack iterative fine-tuning capabilities based on direct preference optimization, the preference-guided code generation system generates comparative data, enabling a large language model to learn from both successful and failed code outputs. Using preference-guided iterative refinement, the preference-guided code generation system enables smaller large language models to match or surpass the accuracy of larger closed-source large language model in various code generation tasks, without relying on training that incorporates vast external datasets or larger auxiliary models.

As indicated by the foregoing discussion, the present disclosure utilizes a variety of terms to describe features and advantages of the preference-guided code generation system. For example, as used herein the term “large language model” includes or refers to a machine learning model trained to perform computer tasks to generate textual content. A large language model includes a computer algorithm or a collection of computer algorithms trainable and/or tunable based on inputs to approximate unknown functions. A large language model includes a neural network (e.g., a deep neural network) that analyzes a language input to generate a predicted output. For example, a large language model includes a neural network that generates code based on a natural language query. In some cases, the large language model utilizes a transformer architecture, which includes mechanisms such as self-attention, to capture contextual relationships in the data.

For example, a large language model includes a computer algorithm with branches, weights, or parameters that change based on training data to improve for a particular task. Thus, a large language model utilizes one or more learning techniques (e.g., supervised or unsupervised learning) to improve in accuracy and/or effectiveness. Similarly, as used herein, a neural network refers to a machine learning model of interconnected nodes (or neurons) organized into layers. A neural network includes parameters or weights between neurons that are adjusted during training to minimize the error (or measure of loss) in generating predictions.

Along these lines, the machine learning models used herein are trainable and/or fine-tunable based on a diverse text corpora to perform natural language processing tasks, such as generating code. For example, the machine learning models consist of layers of interconnected artificial neurons organized in transformer decoder blocks, which learn complex language patterns to generate textual content. In some cases, the machine learning models include models or architectures that utilize self-attention mechanisms in natural language understanding and generation. In particular, in certain embodiments, a large language model refers to an artificial neural network trained by the preference-guided code generation system to generate code based on a set of natural language queries.

Relatedly, as used herein, the term “natural language query” includes or refers to human-readable text input formulated in natural language, which specifies a request or describes a task to be performed. For example, a natural language query provides instructions, requirements, or problem descriptions that guide the large language model in the generation of code responses including code in one or more programming languages. To illustrate, a natural language query includes, “Write a Python function to calculate the factorial of a number” or “Generate an SQL query to retrieve all records where the age is greater than 30.” In some cases, the preference-guided code generation system curates a set of natural language queries from cross-domain sources to ensure a diverse representation of coding problems and solutions for training the large language model.

As used herein, the term “code responses” includes or refers to the output generated by the large language model for the set of natural language queries. For example, the code responses include snippets of code in a programming language. The preference-guided code generation system prompts the large language model to generate the code responses to perform specific tasks (based on the set of natural language queries) supporting a variety of use cases, including data querying (e.g., generating SQL statements for database interaction) and data science workflows (e.g., producing Python code that utilizes libraries such as NumPy for numerical computations or data analysis).

Relatedly, as used herein, the term “correct code responses” includes or refers to the code responses generated by the large language model that meet the desired functional requirements or objectives of the natural language query. In some cases, the preference-guided code generation system generates the correct code responses by comparing the executed results of the code responses to the ground truth executed results derived from the associated ground truth code response and selecting a subset of code responses having executed results that match the ground truth executed results. In some cases, the preference-guided code generation system generates the correct code responses by selecting the executable code responses of the code responses.

Along these lines, as used herein, the term “incorrect code responses” includes or refers to the code responses generated by a large language model that fail to meet the desired functional requirements or objectives of the natural language query. In some cases, the preference-guided code generation system generates the incorrect code responses by comparing the executed results of the code responses to the ground truth executed results derived from the associated ground truth code response and selecting a subset of code responses having executed results that differ from (or do not match) the ground truth executed results). In some cases, the preference-guided code generation system generates the incorrect code responses by selecting the non-executable code responses of the code responses.

As used herein, the term “preference dataset” includes or refers to a collection or grouping of preference pairs of correct code responses matched with incorrect code responses. In some cases, the preference pairs of the preference dataset include one of the correct code responses randomly matched with one of the incorrect code responses. In certain embodiments, the preference-guided code generation system generates the preference dataset to include a specified number of preference pairs defined by a pair threshold. In some cases, if the available number of the correct code responses or the available number of the incorrect code responses are insufficient to meet the pair threshold, the preference-guided code generation system completes the preference dataset by sampling with replacement from the correct code responses and/or the incorrect code responses.

As used herein, the term “dual-loss function” includes or refers to a preference-guided optimization loss function which integrates direct preference optimization (DPO) loss with supervised fine-tuning (SFT) loss. In some cases, the dual-loss function incorporates a direct preference optimization term based on the preference dataset with a supervised fine-tuning term based on the correct code responses. To illustrate, the dual-loss function employs a supervised fine-tuning loss term to regularize training of the large language model, increasing the likelihood of generating correct solutions based on the direct preference optimization loss term.

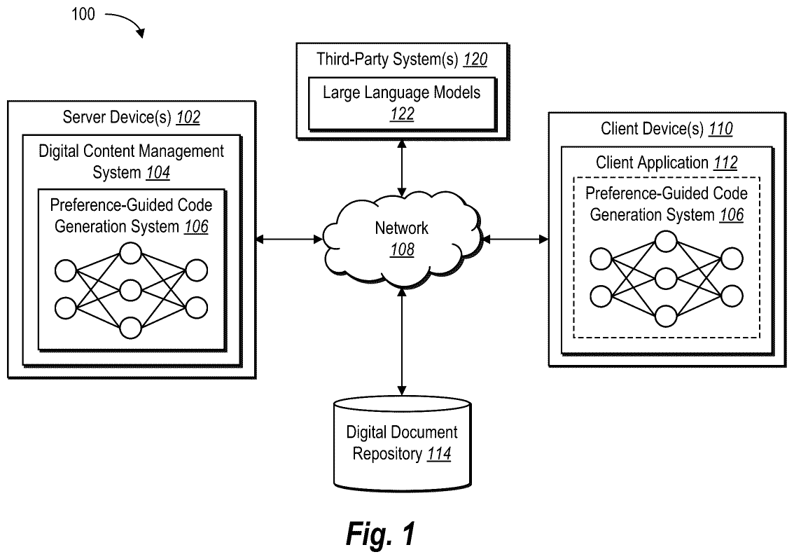

Additional detail regarding the preference-guided code generation system will now be provided with reference to the figures. For example, FIG. 1 illustrates a schematic diagram of an exemplary system environment (e.g., environment 100) in which a preference-guided code generation system 106 operates. As illustrated in FIG. 1, the environment 100 includes server device(s) 102, a network 108, client device(s) 110, digital document repository 114, and third-party system(s) 120.

Although the environment 100 of FIG. 1 is depicted as having a particular number of components, the environment 100 is capable of having any number of additional or alternative components (e.g., any number of servers, client devices, or other components) in communication with the preference-guided code generation system 106 via the network 108. Similarly, although FIG. 1 illustrates a particular arrangement of the server device(s) 102, the network 108, the client device(s) 110, the digital document repository 114, and the third-party system(s) 120, various additional arrangements are possible.

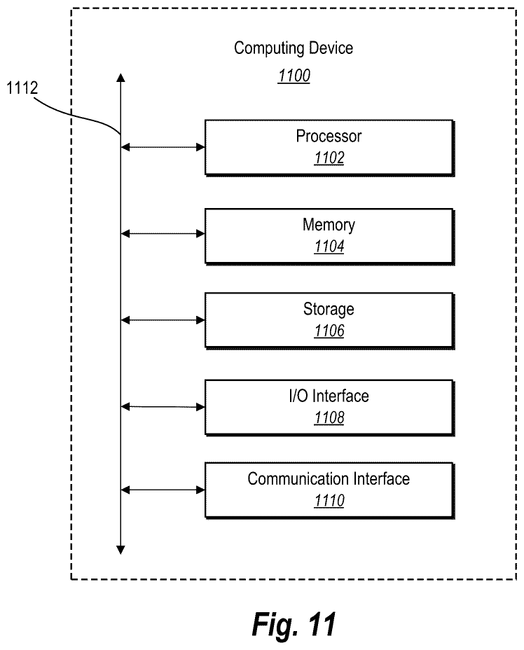

The server device(s) 102, the network 108, the client device(s) 110, the digital document repository 114, and the third-party system(s) 120 are communicatively coupled with each other either directly or indirectly (e.g., through the network 108 discussed in greater detail below in relation to FIG. 11). Moreover, the server device(s) 102 and the client device(s) 110 include one of a variety of computing devices (including one or more computing devices as discussed in greater detail with relation to FIG. 11).

As illustrated in FIG. 1, the environment 100 includes the server device(s) 102 and the digital content management system 104. The server device(s) 102 utilizes the digital content management system 104 to generate, track, store, process, receive, and transmit electronic data including large language models, natural language queries, code responses, and preference datasets. For example, the server device(s) 102 receives or monitors interactions across the client device(s) 110. In some embodiments, the server device(s) 102 transmits content to the client device(s) 110 to cause the client device(s) 110 to display and execute content associated with generating natural language queries, code responses, and preference datasets. For example, the server device(s) 102 presents the large language models, natural language queries, code responses, and preference datasets to client device(s) 110 and displays and/or executes the large language models, natural language queries, code responses, and preference datasets on the client device(s) 110 with the large language models, natural language queries, code responses, and preference datasets displayed and/or executed corresponding to system need (e.g., provides large language models, natural language queries, code responses, and preference datasets for display and/or execution via the client application 112). The server device(s) 102 further accesses and utilizes the digital document repository 114 to store and retrieve information such as large language models, natural language queries, code responses, preference datasets, and/or other data.

Additionally, the server device(s) 102 includes all, or a portion of, the preference-guided code generation system 106. For example, the preference-guided code generation system 106 operates on the server device(s) 102 to access digital content (including large language models, natural language queries, code responses, and preference datasets), determine digital content changes, execute digital content, and provide localization of content changes to the client device(s) 110 and/or finetune large language models. In one or more embodiments, via the server device(s) 102, the preference-guided code generation system 106 generates, executes, and displays large language models, natural language queries, code responses, and preference datasets based on the client device(s) 110 input. Example components of the preference-guided code generation system 106 will be described below with regard to FIG. 11.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 11. Some embodiments of client device(s) 110 are operated by a user to perform a variety of functions via client application 112 such as the generation of the natural language queries, code responses, and preference datasets and/or finetune large language models. The client device(s) 110 include one or more applications (e.g., the client application 112) that access, edit, modify, store, execute, and/or provide, for display, large language models, natural language queries, code responses, and preference datasets. For example, in some embodiments, the client application 112 includes a software application installed on the client device(s) 110. In other cases, however, the client application 112 includes a web browser or other application that accesses a software application hosted on the server device(s) 102.

In one or more embodiments, the preference-guided code generation system 106 is implemented in whole, or in part, by the individual elements of the environment 100. Indeed, as shown in FIG. 1, the preference-guided code generation system 106 is implemented with regard to the server device(s) 102 and the client device(s) 110. In particular embodiments, the preference-guided code generation system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the preference-guided code generation system 106 on the client device(s) 110 represents and/or provides the same or similar functionality as described herein in connection with the preference-guided code generation system 106 on the server device(s) 102. In some embodiments, the preference-guided code generation system 106 on the server device(s) 102 supports the preference-guided code generation system 106 on the client device(s) 110.

In some embodiments, the preference-guided code generation system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., user interactions). In response, the preference-guided code generation system 106 on the server device(s) 102 generates and/or executes large language models, natural language queries, code responses, and preference datasets. The server device(s) 102 then provides the large language models, natural language queries, code responses, and/or preference datasets to the client device(s) 110.

In some embodiments, the preference-guided code generation system 106 includes the third-party system(s) 120 and large language models 122. To illustrate, in one or more embodiments, the preference-guided code generation system 106 interacts with content and services (e.g., a web page or a computing application) hosted on the third-party system(s) 120. The third-party system(s) 120 provide input to the preference-guided code generation system 106 and large language models 122. In response, the preference-guided code generation system 106 generates/modifies digital content including generating natural language queries, code responses, and preference datasets and/or finetunes the large language models 122. The preference-guided code generation system 106 then provides the digital content to the third-party system(s) 120.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

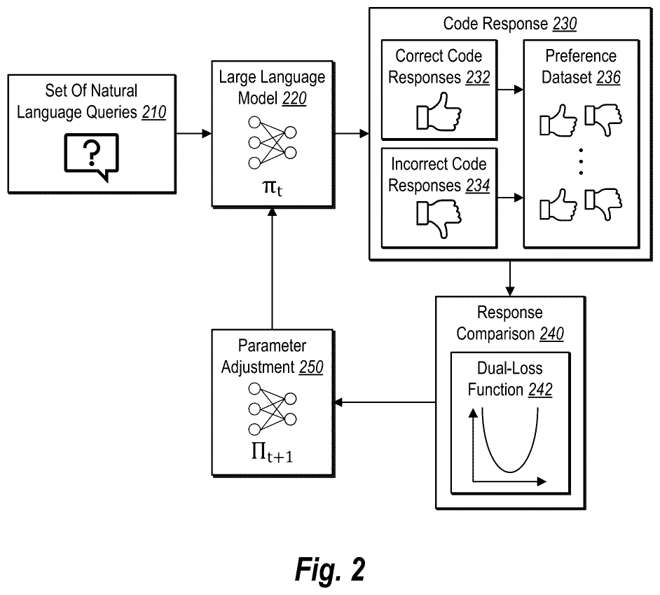

As previously mentioned, in one or more embodiments, the preference-guided code generation system 106 finetunes a large language model to more accurately generate code utilizing preference-guided optimization. For instance, FIG. 2 illustrates an example overview of finetuning a large language model in accordance with one or more embodiments. Additional detail regarding the various acts of FIG. 2 is provided thereafter with reference to subsequent figures.

In one or more embodiments, the preference-guided code generation system 106 utilizes a set of natural language queries 210 to finetune the large language model 220 for code generation. To illustrate, for a data query task, the preference-guided code generation system 106 trains the large language model 220 to generate the corresponding SQL query for a database based on a natural language problem query from the set of natural language queries 210. For example, given the natural language problem query “How many heads of the departments are older than 56?”, the preference-guided code generation system 106 trains the large language model 220 to produce an appropriate SQL query to execute the request. In certain embodiments, for a data science task, the preference-guided code generation system 106 trains the large language model 220 to generate the correct Python code to solve a given data science query of the set of natural language queries 210. For example, given the data science query: “I have a 2D array to represent a many-many mapping. What is the quickest way to zero out the second row and the first column?”, the preference-guided code generation system 106 trains the large language model 220 to generate appropriate Python code to solve the problem.

In some cases, the large language model 220 includes or refers to a machine learning model trained to perform computer tasks to generate textual content. The large language model 220 includes a neural network (e.g., a deep neural network) that analyzes a language input to generate a predicted output. For example, the large language model 220 includes a neural network that generates code based on a natural language query. In some cases, the large language model 220 utilizes a transformer architecture, which includes mechanisms such as self-attention, to capture contextual relationships in the data.

Along these lines, the large language model 220 is trainable and/or fine-tunable based on a diverse text corpora to perform natural language processing tasks, such as generating code. For example, the large language model 220 consists of layers of interconnected artificial neurons organized in transformer decoder blocks, which learn complex language patterns to generate textual content. In some cases, the large language model 220 includes a model or architecture that utilizes self-attention mechanisms in natural language understanding and generation. In particular, in certain embodiments, the large language model 220 refers to an artificial neural network trained by the preference-guided code generation system 106 to generate code based on the set of natural language queries 210.

In one or more embodiments, the preference-guided code generation system 106 utilizes the set of natural language queries 210 including or referring to human-readable text input formulated in natural language, which specifies a request or describes a task to be performed. For example, the set of natural language queries 210 provide instructions, requirements, or problem descriptions that guide large language model 220 in the generation of code responses including code in one or more programming languages. To illustrate, a natural language query includes, “Write a Python function to calculate the factorial of a number” or “Generate an SQL query to retrieve all records where the age is greater than 30.” In some cases, the preference-guided code generation system 106 curates the set of natural language queries 210 from cross-domain sources to ensure a diverse representation of coding problems and solutions for training the large language model 220.

In certain embodiments, the preference-guided code generation system 106 pairs the set of natural language queries 210 with a corresponding set of ground truth code responses (e.g., ground truth sets of computer code). For example, the preference-guided code generation system 106 provides the set of ground truth code responses to serve as the correct and authoritative solutions for the set of natural language queries 210. In some cases, the preference-guided code generation system 106 employs a multi-criteria evaluation system to ensure the quality of the set of ground truth code responses based on functional correctness and adherence to coding constraints.

As further shown in FIG. 2, preference-guided code generation system 106 causes the large language model 220 to generate code responses 230. As used herein, the code responses 230 include or refer to the output generated by the large language model 220 for the set of natural language queries 210, such as snippets of code. The preference-guided code generation system 106 prompts the large language model 220 to generate the code responses 230 to perform specific tasks (based on the set of natural language queries 210) supporting a variety of use cases, including data querying (e.g., generating SQL statements for database interaction) and data science workflows (e.g., producing Python code that utilizes libraries such as NumPy for numerical computations or data analysis). In one or more embodiments, at each iteration of training, the preference-guided code generation system 106 causes the large language model 220 to generate multiple responses based on each of the natural language queries of the set of natural language queries 210 for the code responses 230.

In some cases, the preference-guided code generation system 106 selects correct code responses 232 and incorrect code responses 234 from the code responses 230. As used herein, the correct code responses 232 include or refer to the code responses 230 generated by the large language model 220 that meet the desired functional requirements or objectives of the set of natural language queries 210. In some cases, the preference-guided code generation system 106 generates the correct code responses 232 by comparing the executed results of the code responses 230 to the ground truth executed results derived from the associated ground truth code response and selecting a subset of code responses having executed results that match the ground truth executed results. In some cases, the preference-guided code generation system 106 generates the correct code responses 232 by selecting the executable code responses of the code responses 230.

Along these lines, as used herein, the incorrect code responses 234 include or refer to the code responses 230 generated by a large language model 220 that fail to meet the desired functional requirements or objectives of the set of natural language queries 210. In some cases, the preference-guided code generation system 106 generates the incorrect code responses 234 by comparing the executed results of the code responses 230 to the ground truth executed results derived from the associated ground truth code response and selecting a subset of code responses having executed results that differ from (or do not match) the ground truth executed results). In some cases, the preference-guided code generation system 106 generates the incorrect code responses 234 by selecting the non-executable code responses of the code responses 230.

In one or more embodiments, the preference-guided code generation system 106 generates the preference dataset 236 from pairs of the correct code responses 232 and the incorrect code responses 234. For example, the preference-guided code generation system 106 generates the preference dataset 236 to include preference pairs, where each preference pair includes one of the correct code responses 232 randomly matched with one of the incorrect code responses 234. In certain embodiments, the preference-guided code generation system 106 generates the preference dataset 236 to include a specified number of preference pairs. In some cases, if the available number of the correct code responses 232 or the available number of the incorrect code responses 234 are insufficient to meet the required number of preference pairs, the preference-guided code generation system 106 completes the preference dataset 236 by sampling with replacement from the correct code responses 232 and/or the incorrect code responses 234.

As further shown in FIG. 2, in one or more embodiments, the preference-guided code generation system 106 refines the large language model 220 by performing a response comparison 240 utilizing a dual-loss function 242. For example, the preference-guided code generation system 106 refines the large language model 220 using preference-guided optimization based on the dual-loss function 242 which integrates direct preference optimization (DPO) with supervised fine-tuning (SFT). In some cases, the preference-guided code generation system 106 utilizes the dual-loss function 242 to refine the large language model 220 using direct preference optimization based on the preference dataset 236. Furthermore, to regularize the output of the dual-loss function 242, the preference-guided code generation system 106 incorporates supervised fine-tuning into the dual-loss function 242 based on the correct code responses 232. Using the dual-loss function 242, embodiments of the preference-guided code generation system 106 improve the likelihood of the large language model 220 generating correct code responses.

In one or more embodiments, the preference-guided code generation system 106 performs a parameter adjustment 250 to adjust the parameters of the large language model 220. For example, using iterative refinement, the preference-guided code generation system 106 performs the parameter adjustment 250 to minimize the dual-loss function 242 until the improvement becomes marginal (e.g., indicating convergence). In certain embodiments, the preference-guided code generation system 106 updates the parameters of the large language model 220 using an optimization algorithm (e.g., Adaptive Moment Estimation, Stochastic Gradient Descent) to reduce incorrect code responses according to the dual-loss function 242. In one or more embodiments, the preference-guided code generation system 106 executes training iterations of the steps shown in FIG. 2 until a difference for the dual-loss function 242 of consecutive iterations satisfies/meets a convergence threshold (e.g., a minimum change between consecutive iterations required to continue training).

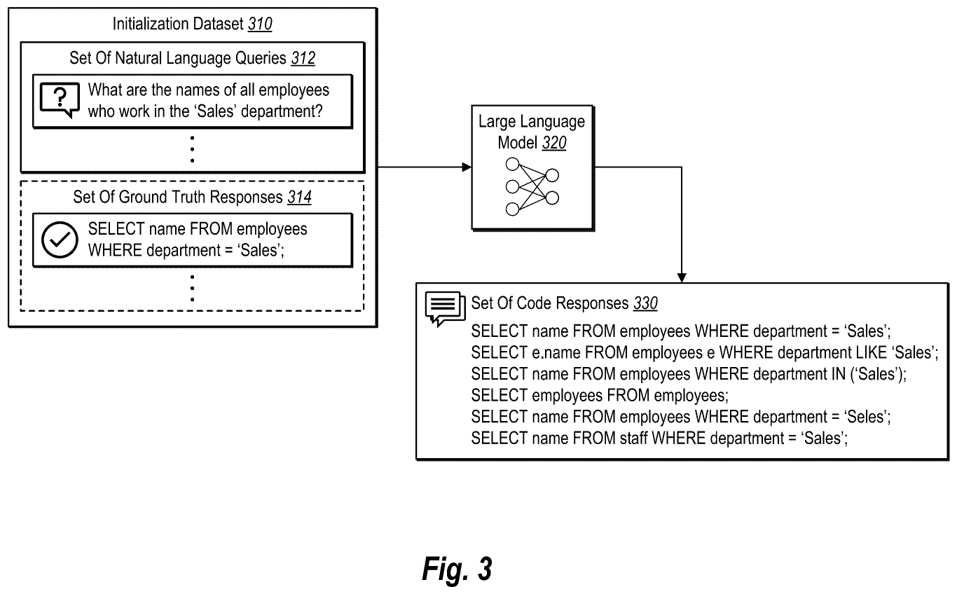

As mentioned, the preference-guided code generation system 106 trains a large language model based on an initialization dataset that includes a set of natural language queries. FIG. 3 illustrates an example of the preference-guided code generation system causing a large language model to generate a set of code responses from an initialization dataset in accordance with one or more embodiments.

As shown in FIG. 3, the preference-guided code generation system 106 trains a large language model 320 utilizing an initialization dataset 310. As shown, the initialization dataset 310 includes a set of natural language queries 312 of human-readable text input formulated in natural language. For example, the preference-guided code generation system 106 utilizes the initialization dataset 310 to provide instructions, requirements, or problem descriptions that guide the large language model 320 in the generation of a set of code responses 330. In certain embodiments, the preference-guided code generation system 106 pairs the set of natural language queries 312 with a set of ground truth code responses 314. For example, the preference-guided code generation system 106 provides the set of ground truth code responses 314 to serve as the correct and authoritative solutions for the set of natural language queries 312.

In some embodiments, the preference-guided code generation system 106 utilizes the initialization dataset 310 such as represented by

$$D = {\{ ( {x}_{i} , {y}_{i} ) \}}_{i = 1}^{n} ,$$

where each xᵢ is a natural language query of the set of natural language queries 312, and yᵢ is the corresponding ground truth code response of the set of ground truth code responses 314. In one or more embodiments, the preference-guided code generation system 106 utilizes the initialization dataset 310, which includes the set of natural language queries 312 and the set of ground truth code responses 314, for training the large language model 320, as described below.

In one or more embodiments, the preference-guided code generation system 106 provides the initialization dataset 310 to the large language model 320. As described above, the large language model 320 includes a neural network trained and/or tuned based on inputs to approximate unknown functions. For example, the large language model 320 includes a large language model that has been pre-trained on diverse datasets encompassing both natural and programming languages. In some cases, the preference-guided code generation system 106 trains the large language model 320 to receive a prompt—such as a natural language query—and generate the corresponding code response by predicting the next token in the sequence. For instance, the preference-guided code generation system 106 models the code generation as the conditional probability of a code sequence y=(y₁, y₂, . . . , y_{T}) given an input prompt x:

$$P ( y \vert x ) = {{\prod }_{t = 1}}^{T} P ( {y}_{t} \vert {y}_{< t} , x )$$

where x is the input prompt, y is the generated code sequence of length T, and y_{<t}=(y₁, y₂, . . . , y_{T-1}) represents the tokens generated before timestep t.

In certain embodiments, the preference-guided code generation system 106 generates a set of code responses 330 for each iteration t. For example, the preference-guided code generation system 106 causes the large language model 320 to generate multiple code responses (e.g., the set of code responses 330) for each natural language query in the initialization dataset 310 (e.g., xᵢ ϵD). Specifically, embodiments of the preference-guided code generation system 106 cause the large language model 320 to generate M distinct code samples for each xᵢ, as represented by:

$${\hat{y}}_{i}^{m} ∼ {π}_{t} ( {x}_{i} ) , for each m ∈ \{ 1 , 2 , … , M \}$$

By generating multiple code responses for each natural language query in the initialization dataset 310, embodiments of the preference-guided code generation system 106 introduce diversity in the large language model 320 output, providing a richer dataset in the set of code responses 330 for composing preference datasets. To illustrate, as shown in FIG. 3, for a natural language query of “What are the names of all employees who work in the ‘Sales’ department?”, the preference-guided code generation system 106 causes the large language model to generate a set of code responses such as:

SELECT name FROM employees WHERE department = ‘Sales’;
SELECT e.name FROM employees e WHERE department LIKE ‘Sales’;
SELECT name FROM employees WHERE department IN (‘Sales’);
SELECT employees FROM employees;
SELECT name FROM employees WHERE department = ‘Seles’;
SELECT name FROM staff WHERE department = ‘Sales’;

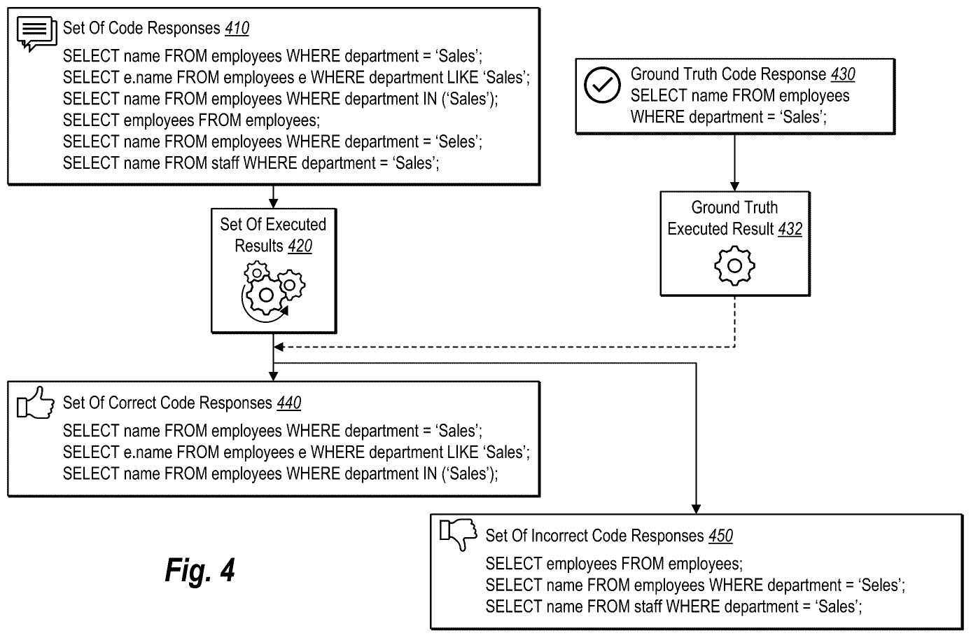

As mentioned, the preference-guided code generation system 106 selects a set of correct code responses and a set of incorrect code responses from the set of code responses generated by the large language model. FIG. 4 illustrates an example of generating a set of correct code responses and a set of incorrect code responses from a set of code responses in accordance with one or more embodiments.

As shown in FIG. 4, embodiments of the preference-guided code generation system 106 generate a set of correct code responses 440 and a set of incorrect code responses 450 based on a set of executed results 420. For example, for each code response

$$( {\hat{y}}_{i}^{m} )$$

of the set of code responses 410 (Y), the preference-guided code generation system 106 assesses the correctness the code response by executing the code response and comparing the executed result to the ground truth executed result yᵢ. The preference-guided code generation system 106 categorizes code responses with correct executions into the set of correct code responses 440

$$( {Y}_{i}^{( c )} )$$

and categorizes code responses with incorrect executions into the set of incorrect code responses 450

$$( {Y}_{i}^{( r )} ) .$$

To illustrate, to generate the set of correct code responses 440 and the set of incorrect code responses 450, the preference-guided code generation system 106 generates the set of executed results 420. For each code response of the set of code responses 410, embodiments of the preference-guided code generation system 106 execute the code response to generate an executed result for the set of executed results 420. For example, in an embodiment such as illustrated in FIG. 4 utilizing a SQL “Employees” table of:

| Id | Name | Department |
|---|---|---|
| 1 | Alice Johnson | Sales |
| 2 | Bob Smith | Marketing |
| 3 | Charlie Brown | Sales |
| 4 | Diana Prince | HR |

the preference-guided code generation system 106 executes a code response of the set of code responses 410 corresponding to an SQL query “SELECT e.name FROM employees e WHERE department LIKE ‘Sales’” to generate an executed result of the set of executed results 420 such as:

Name

Alice Johnson
Charlie Brown

Similarly, utilizing the SQL “Employees” table from above, the preference-guided code generation system 106 executes a code response of the set of code responses 410 corresponding to an SQL query of “SELECT name FROM staff WHERE department=‘Sales’” to generate an executed result of the set of executed results 420 such as:
ERROR: Table ‘staff’ does not exist.
   Similarly, as illustrated in FIG. 4, the preference-guided code generation system 106 executes each of the set of code responses 410 to generate each executed result of the set of executed results 420.

Furthermore, in one or more embodiments, the preference-guided code generation system 106 executes a ground truth code response 430 to generate a ground truth executed result 432. For example, the preference-guided code generation system 106 receives the ground truth code response 430 associated with the natural language query the large language model used to generate the set of code responses 410 and executes the ground truth code response 430 to generate a ground truth executed result 432. To illustrate, in the embodiment utilizing the SQL “Employees” table described above, the preference-guided code generation system 106 executes the ground truth code response 430 corresponding to an SQL query of “SELECT name FROM employees WHERE department=‘Sales’” to generate the ground truth executed result 432 such as:

Name

Alice Johnson
Charlie Brown

Based on the set of executed results 420, embodiments of the preference-guided code generation system 106 generate the set of correct code responses 440 and the set of incorrect code responses. For example, the preference-guided code generation system 106 generates the set of correct code responses 440 as a subset of the set of code responses 410 with executed results that match the ground truth executed result 432 of the ground truth code response 430. In certain embodiments, the preference-guided code generation system 106 generates the set of correct code responses 440 as a subset of the set of code responses 410 by selecting the executable code responses of the set of code responses 410 (e.g., without utilizing the ground truth executed result 432).

Similarly, in one or more embodiments, the preference-guided code generation system 106 generates the set of incorrect code response 450 based on the set of executed results 420. In certain embodiments, the preference-guided code generation system 106 generates the set of incorrect code responses 450 as a subset of the set of code responses 410 with executed results that differ from the ground truth executed result 432 of the ground truth code response 430 based on code responses of the set of code responses 410 that include syntax errors, execution errors, and/or incorrect results. In certain embodiments, the preference-guided code generation system 106 generates the set of incorrect code responses 450 as a subset of the set of code responses 410 by selecting the non-executable code responses of the set of code responses 410 (e.g., without utilizing the ground truth executed result 432).

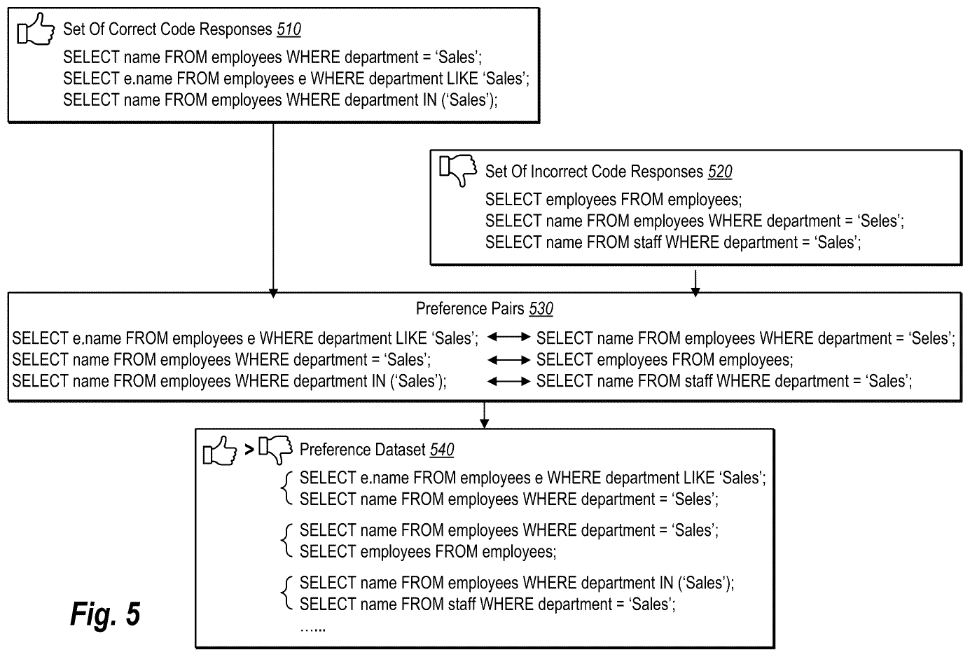

As mentioned, the preference-guided code generation system 106 utilizes a preference dataset generated from a set of code responses to finetune a large language model using direct preference optimization and supervised fine-tuning. FIG. 5 illustrates an example of generating a preference dataset to finetune a large language model in accordance with one or more embodiments.

As shown in FIG. 5, in one or more embodiments, the preference-guided code generation system 106 generates a preference dataset 540 which includes preference pairs of correct code responses matched with incorrect code responses. For example, the preference-guided code generation system 106 matches a correct code response from a set of correct code responses 510 with an incorrect code response from a set of incorrect code responses 520 to generate preference pairs 530. In this way, embodiments of the preference-guided code generation system 106 utilize the preference dataset 540 capture the relative quality of the code generated by a large language model. By generating the preference pairs 530 with a quality disparity (e.g., by pairing correct code responses with incorrect code responses), the preference-guided code generation system 106 encodes relative quality judgments between pairs of code responses, causing the large language model to learn to prioritize higher-quality code responses.

To illustrate, in one or more embodiments, the preference-guided code generation system 106 constructs the preference dataset 540 (Dₜ) as shown in FIG. 5. In certain embodiments, the preference-guided code generation system 106 updates the preference dataset 540 at every iteration t. For example, for each natural language query of the set of natural language queries (xᵢ) the preference-guided code generation system 106 generates an amount K of the preference pairs 530 by randomly sampling from the set of correct code responses 510

$$( {\hat{y}}_{i}^{{c}_{k}} ∈ {Y}_{i}^{( c )} )$$

and randomly sampling from the set of incorrect code responses 520

$$( {\hat{y}}_{i}^{{r}_{k}} ∈ {Y}_{i}^{( r )} )$$

to generate preference pairs 530 such that:

$$( {\hat{y}}_{i}^{{c}_{k}} , {\hat{y}}_{i}^{{r}_{k}} ) , for each k ∈ [ K ]$$

In one or more embodiments, the preference-guided code generation system 106 utilizes a consistent size for the preference dataset 540. For example, if the set of correct code responses 510 and/or the set of incorrect code responses 520 contains fewer than a predetermined number of code responses (e.g., a pair threshold K), the preference-guided code generation system 106 utilizes sampling with replacement. Using sampling with replacement, embodiments of the preference-guided code generation system 106 utilize code response(s) from the set of correct code responses 510 and/or the set of incorrect code responses 520 multiple times to generate the preference dataset 540. In this way, embodiments of the preference-guided code generation system 106 generate a uniform number (e.g., K) of preference pairs 530, regardless of the actual size of the set of correct code responses 510 and/or the set of incorrect code responses 520.

In certain embodiments, the preference-guided code generation system 106 selectively employs sampling with replacement to generate the preference dataset 540. For example, the preference-guided code generation system 106 applies sampling with replacement selectively to either the set of correct code responses 510 and/or the set of incorrect code responses 520 in response to having fewer than a pair threshold of responses (while the set with sufficient code responses, is used without modification). By selectively employing sampling with replacement and augmenting only the sets that do not meet the pair threshold, certain embodiments of the preference-guided code generation system 106 ensure the preference dataset 540 includes diverse code responses from the sets with sufficient responses.

In certain embodiments, the preference-guided code generation system 106 defines the preference dataset 540 at iteration t such as the following:

$${D}_{t} = \{ ( {x}_{i} , {\hat{y}}_{i}^{{c}_{k}} , {\hat{y}}_{i}^{{r}_{k}} ) \vert for all {x}_{i} ∈ D and k ∈ [ K ] \}$$

containing n×K preference triplets, where n corresponds to the size of the initialization dataset D, which remains constant throughout iterations t. To illustrate, in one or more embodiments, the preference-guided code generation system 106 generates the preference dataset 540 as sets of triplets incorporating the preference pairs 530 and the corresponding natural language query used to generate the preference pairs 530.

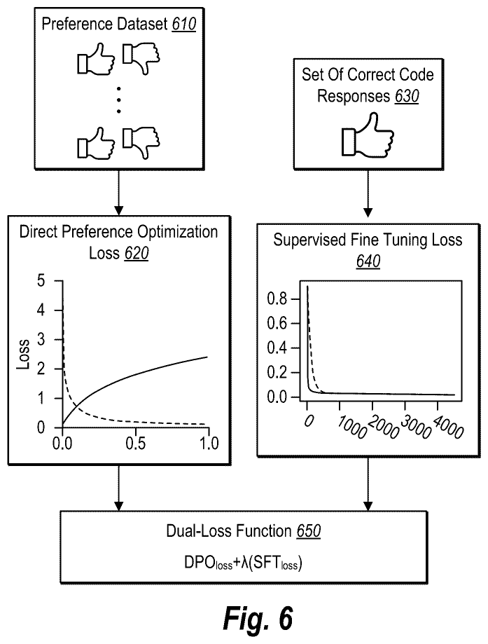

As mentioned, embodiments of the preference-guided code generation system 106 perform preference-guided optimization to finetune large language models using direct preference optimization in combination with supervised fine tuning. FIG. 6 illustrates an example of utilizing a dual-loss function to finetune a large language model in accordance with one or more embodiments.

As shown in FIG. 6, the preference-guided code generation system 106 generates a dual-loss function 650 by combining a direct preference optimization loss 620 with a supervised fine-tuning loss 640. In some cases, the preference-guided code generation system 106 uses the supervised fine-tuning loss 640 to regularize the dual-loss function 650 to prioritize the likelihood of generating correct solutions from the direct preference optimization loss 620. For example, through the use of the direct preference optimization loss 620 balanced with the supervised fine-tuning loss 640, the preference-guided code generation system 106 ranks the correct response higher and increases the likelihood of correct responses for the set of correct code responses 630.

As shown, embodiments of the preference-guided code generation system 106 generates the direct preference optimization loss 620 based on the preference dataset 610. For example, the preference-guided code generation system 106 generates the direct preference optimization loss 620 by performing pairwise comparisons between the correct code responses and the incorrect code responses of the preference pairs. In some cases, the direct preference optimization loss 620 utilizes the direct preference optimization loss 620 to cause the large language model to favor correct code responses over incorrect code responses in the code responses generated by the large language model based on the preference dataset 610. For example, the preference-guided code generation system 106 generates the direct preference optimization loss 620 based on the preference dataset 610 such as defined by:

$${D}_{t} = \{ ( {x}_{i} , {\hat{y}}_{i}^{{c}_{k}} , {\hat{y}}_{i}^{{r}_{k}} ) \vert for all {x}_{i} ∈ D and k ∈ [ K ] \}$$

In certain embodiments, the preference-guided code generation system 106 utilizes the direct preference optimization loss 620 such as defined by:

$$arg {min}_{πθ} [ - {𝔼}_{( {x}_{i} , {y}_{i}^{c} , {y}_{i}^{r} ) ∼ {D}_{t}} [ log σ ( β ( log \frac{{π}_{θ} ( {y}_{i}^{c} \vert {x}_{i} )}{{π}_{t} ( {y}_{i}^{c} \vert {x}_{i} )} - log \frac{{π}_{θ} ( {y}_{i}^{r} \vert {x}_{i} )}{{π}_{t} ( {y}_{i}^{r} \vert {x}_{i} )} ) ) ]$$

As also shown, in certain embodiments, the preference-guided code generation system 106 generates the supervised fine-tuning loss 640 based on the set of correct code responses 630 generated by the large language model. In some cases, the preference-guided code generation system 106 determines the supervised fine-tuning loss 640 utilizing supervised fine tuning to increase a likelihood of the large language model generating correct code responses based on the set of correct code responses 630 in the preference pairs. For example, the preference-guided code generation system 106 generates the supervised fine-tuning loss 640 based on the set of correct code responses 630 such as defined by:

$${D}_{t}^{c} = \{ ( {x}_{i} , {\hat{y}}_{i}^{{c}_{k}} ) \vert for all {x}_{i} ∈ D and k ∈ [ K ] \}$$

In certain embodiments, the preference-guided code generation system 106 utilizes the supervised fine-tuning loss 640 such as defined by:

$${𝔼}_{( {x}_{i} , {y}_{i}^{c} ) ∼ {D}_{t}} ( log {π}_{θ} ( {y}_{i}^{c} \vert {x}_{i} ) ) ]$$

As further shown in FIG. 6, the preference-guided code generation system 106 integrates the direct preference optimization loss 620 with the supervised fine-tuning loss 640 to generate the dual-loss function 650. For example, the preference-guided code generation system 106 generates the dual-loss function 650 to include the direct preference optimization loss 620 and the supervised fine-tuning loss 640 to increase a probability of generating correct code responses and reducing a probability of generating incorrect code responses. In certain embodiments, the preference-guided code generation system 106 utilizes the dual-loss function 650 such as defined by:

$${π}_{t + 1} = arg {min}_{πθ} [ - {𝔼}_{( {x}_{i} , {y}_{i}^{c} , {y}_{i}^{r} ) ∼ {D}_{t}} [ log σ ( β ( log \frac{{π}_{θ} ( {y}_{i}^{c} \vert {x}_{i} )}{{π}_{t} ( {y}_{i}^{c} \vert {x}_{i} )} - log \frac{{π}_{θ} ( {y}_{i}^{r} \vert {x}_{i} )}{{π}_{t} ( {y}_{i}^{r} \vert {x}_{i} )} ) ) ] - \text{?} {𝔼}_{( {x}_{i} , {y}_{i}^{c} ) ∼ {D}_{t}} ( log {π}_{θ} ( {y}_{i}^{c} \vert {x}_{i} ) ) ]$$

As shown, in some cases, the preference-guided code generation system 106 utilizes a hyperparameter λ to balance the contributions of the direct preference optimization loss 620 and the supervised fine-tuning loss 640.

In one or more embodiments, the preference-guided code generation system 106 utilizes the dual-loss function 650 to iteratively train the large language model. As discussed in relation to FIGS. 1-6, embodiments of the preference-guided code generation system 106 finetune the large language model iteratively, causing the large language model to generate code responses, the set of correct code responses 630, the set of incorrect code responses, and the preference dataset 610 for each natural language query input. For example, the preference-guided code generation system 106 iteratively trains the large language model utilizing iterative losses determined via the dual-loss function 650 at a plurality of timesteps of the large language model. In certain embodiments, the preference-guided code generation system 106 utilizes an algorithm such as “Algorithm 1” to iteratively refine the large language model utilizing the dual-loss function 650:

Algorithm 1: CODEULTRA

```
$Input : Training set D = {\{ ( {x}_{i} , {y}_{i} ) \}}_{i = 1}^{n} ; Initial base model {π}_{0} ; Number of code responses$
per input M; Number of preference pairs per input K; Number of iterations T;
Hyperparameter λ.
for t = 0 to T − 1 do
Initialize preference dataset Dₜ = Ø
  $ForEach {x}_{i} ∈ D , Initialize correct code set {Y}_{i}^{( c )} = ∅ ;$
  $Initialize incorrect code set {Y}_{i}^{( r )} = ∅ ;$
  for k = 1 to M do
    $Generate response {\hat{y}}_{i}^{k} ∼ {π}_{t} ( {x}_{i} ) ;$
    $if Execution result of {\hat{y}}_{i}^{k} matches ground truth {y}_{i} then$
      $Add {\hat{y}}_{i}^{k} to {Y}_{i}^{( c )} ;$
    else
      $Add {\hat{y}}_{i}^{k} to {Y}_{i}^{( r )} ;$
  for k = 1 to K do
    $Randomly sample {\hat{y}}_{i}^{{c}_{k}} from {Y}_{i}^{( c )} ( with replacement if \vert {Y}_{i}^{( c )} \vert < K ) ;$
    $Randomly sample {\hat{y}}_{i}^{{r}_{k}} from {Y}_{i}^{( r )} ( with replacement if \vert {Y}_{i}^{( r )} \vert < K ) ;$
    $Add ( {x}_{i} , {\hat{y}}_{i}^{{c}_{k}} , {\hat{y}}_{i}^{{r}_{k}} ) to {D}_{t} ;$
Update model πₜ₊₁ by minimizing the combined loss:
${π}_{t + 1} = arg {min}_{πθ} [ - {𝔼}_{( {x}_{i} , {y}_{i}^{c} , {y}_{i}^{r} ) ∼ {D}_{t}} [ log σ ( β ( log \frac{{π}_{θ} ( {y}_{i}^{c} \vert {x}_{i} )}{{π}_{t} ( {y}_{i}^{c} \vert {x}_{i} )} - log \frac{{π}_{θ} ( {y}_{i}^{r} \vert {x}_{i} )}{{π}_{t} ( {y}_{i}^{r} \vert {x}_{i} )} ) ) ] - \text{?} {𝔼}_{( {x}_{i} , {y}_{i}^{c} ) ∼ {D}_{t}} ( log {π}_{θ} ( {y}_{i}^{c} , {x}_{i} ) ) ]$
```

In certain embodiments, the preference-guided code generation system 106 finetunes the large language model by modifying parameters of the large language model to reduce incorrect code responses. In some embodiments, the preference-guided code generation system 106 sets K=10 for each iteration t, generating 10 positive and negative sample pairs per natural language query. Furthermore, in some embodiments, the preference-guided code generation system 106 updates the parameters of the large language model based on a set of training hyperparameters for data query and data science such as the following:

| | Parameters | Value |
|---|---|---|
| Data query | Number of epochs | 1 |
| | Learning rate | 5 × 10⁻⁵ |
| | β | 0.1 |
| | Batch size | 16 |
| | Gradient accumulation steps | 1 |
| | Maximum sequence length | 2048 |
| | DeepSpeed Zero stage | 2 |
| | Weight decay | 0.0001 |
| | LoRA rank | 8 |
| | λ | 1.0 |
| Data science | Number of epochs | 1 |
| | Learning rate | 5 × 10⁻⁵ |
| | β | 0.5 |
| | Batch size | 16 |
| | Gradient accumulation steps | 1 |
| | Maximum sequence length | 512 |
| | DeepSpeed Zero stage | 2 |
| | Weight decay | 0.0001 |
| | LoRA rank | 8 |
| | λ | 0.5 |

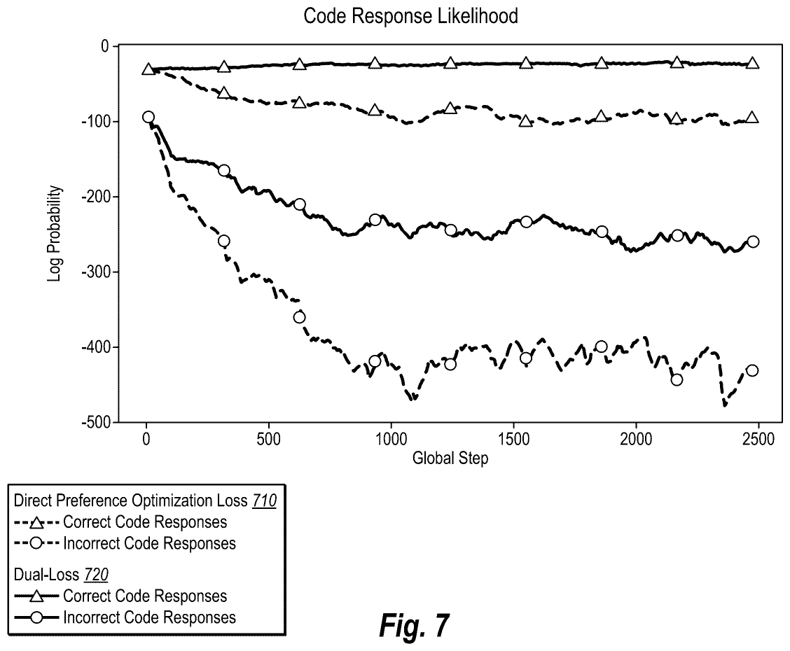

As mentioned, the preference-guided code generation system 106 utilizes code responses to finetune large language models with preference-guided optimization. FIG. 7 illustrates a quantitative example of the effect of utilizing a dual-loss function on code response likelihood when finetuning a large language model in accordance with one or more embodiments.

As illustrated by FIG. 7, embodiments of the preference-guided code generation system 106 utilize a dual-loss function to accurately rank code responses during training. For example, by incorporating both direct preference optimization and supervised fine-tuning loss into training, the preference-guided code generation system 106 improves accuracy to rank correct code responses higher than incorrect code responses. Furthermore, by incorporating the supervised fine-tuning loss, embodiments of the preference-guided code generation system 106 regularize the training. For example, the preference-guided code generation system 106 incorporates the supervised fine-tuning loss to prevent a decrease in the generation of correct code responses and/or to increase the generation probability of correct code responses.

For example, as shown by as shown by the direct preference optimization loss results 710 (e.g., dashed lines), when utilizing direct preference optimization loss alone, the likelihood of both correct and rejected code decreases during training. However, as shown by the dual-loss results 720 (e.g., solid lines), when utilizing a dual-loss that includes both direct preference optimization loss and supervised fine tuning loss, the likelihood of correct answers stabilizes. In this way, the preference-guided code generation system 106 increases the likelihood of the large language model to generate a robust set of code responses for the preference dataset during training.

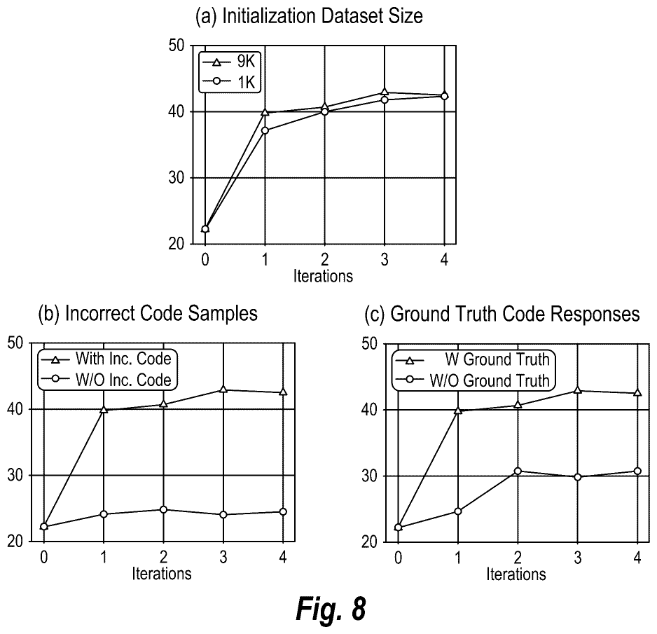

As mentioned, the preference-guided code generation system 106 utilizes preference-guided optimization to efficiently finetune large language models to generate accurate code responses. FIG. 8 illustrates quantitative results of ablation studies for the preference-guided code generation system corresponding to negative samples, initialization dataset size, and ground truth code responses in accordance with one or more embodiments.

As shown in FIG. 8(a), the preference-guided code generation system 106 achieves strong results with a limited number of high-quality annotations. For example, based a comparison between a random selection of 1K to 9K question-code pairs (chosen from a diverse dataset with 12,751 question-SQL pairs across 95 databases, covering over 37 domains), the preference-guided code generation system 106 performs comparably when using the 1K dataset to the full 9K sample set. In particular, the results shown by FIG. 8(a) reveal similar trends for the preference-guided code generation system 106, showing the training using 1K question-code pairs reaching a peak execution accuracy of 42.4 and the training using the full 9K sample set reaching a peak execution accuracy of 43.1. The minor differences of FIG. 8(a) suggest that the preference-guided code generation system 106 does not heavily rely on large volumes of training data and generalizes well with fewer annotations, providing marked improvements in computational efficiency over existing systems.

As further shown in FIG. 8(b), the preference-guided code generation system 106 provides an improvement in performance when training using negative samples (e.g., preference-guided optimization). As shown by FIG. 8(b), without negative samples, the preference-guided code generation system 106 performance plateaus across iterations, remaining close to the baseline. In contrast, by incorporating negative samples, the preference-guided code generation system 106 demonstrates steady performance improvements over successive iterations. As shown by FIG. 8(b), by incorporating negative samples, embodiments of the preference-guided code generation system 106 provide significant improvements over supervised fine-tuning in the ability of large language models to distinguish between optimal and suboptimal responses, thereby boosting system accuracy.

Moreover, as shown in FIG. 8(c), embodiments of the preference-guided code generation system 106 still provide substantial improvements in code quality when training without ground truth code responses. In particular, in the absence of ground truth responses, the preference-guided code generation system 106 considers executable code responses to be correct code responses and non-executable code responses to be incorrect code responses. As shown by FIG. 8(c), the preference-guided code generation system 106 provides notable gains in accuracy when finetuning large language models, even without the use of ground truth code responses.

In particular, the accuracy of the large language model finetuned by the preference-guided code generation system 106 without the use of ground truth code responses rose from 22.3 to 30.9. Moreover, the proportion of executable code generated by the large language model finetuned by the preference-guided code generation system 106 without the use of ground truth code responses surged from 59.8% to 89.7%. These gains demonstrate that the large language model effectively learned to avoid common errors, such as syntax issues or missing database tables In particular, as demonstrated by FIG. 8(c), the use of executability as a metric by the preference-guided code generation system 106 still enables substantial large language model improvements, making the preference-guided code generation system 106 applicable even without high-quality annotations.

Moreover, as shown below in Table 1, the preference-guided code generation system 106 is effective compared to existing systems when generating code for data query and data science tasks. For the data query task of Table 1, the models are tasked with training the large language model to generate an SQL query for a database given a natural language problem description. For the data science task of Table 1, the models are tasked with finetuning a large language model to generate the correct Python code to solve a given data science problem.

TABLE 1

| Data Set 1 | | Data Set 2 | | Data Set 3 |
|---|---|---|---|---|
| EX | EM | EX | EM | Pass@1 |

Existing Models

| | | | | | |
|---|---|---|---|---|---|
| LLM1 - Base Open-source | 59.3 | 55.1 | 22.3 | 19.5 | 28.2 |
| LLM2 - Base Open-source | 49.9 | 46.7 | 21.2 | 19.1 | 24.2 |
| LLM1 - SFT-tuned LLM | 67.9 | 64.7 | 35.6 | 30.7 | 30.0 |
| LLM2 - SFT-tuned LLM | 65.8 | 62.8 | 34.5 | 29.8 | 27.4 |
| Closed-Source LLM | 74.4 | 71.2 | 46.3 | 43.2 | 49.4 |

Preference-Guided Code Generation System

| | | | | | |
|---|---|---|---|---|---|
| LLM1 - Base Open-source | 59.3 | 55.1 | 22.3 | 19.5 | 28.2 |
| LLM1 - Iteration 1 (π₁) | 67.8 | 63.9 | 37.8 | 33.2 | 43.2 |
| LLM1 - Iteration 2 (π₂) | 72.4 | 68.3 | 40.8 | 36.0 | 46.8 |
| LLM1 - Iteration 3 (π₃) | 76.6 | 72.5 | 43.1 | 38.6 | 48.6 |
| LLM1 - Iteration 4 (π₄) | 76.3 | 72.1 | 42.6 | 38.3 | 48.2 |

The experiments of Table 1 utilize Data Set 1 (10,181 questions with 5,693 unique SQL queries across 200 databases in 138 domains), Data Set 2 (12,751 question-SQL pairs across 95 large databases, covering over 37 domains), and Data Set 3 (1,000 data science problems sourced from Stack Overflow, covering seven Python libraries related to analysis in data science). The Data Query task is measured using Execution Accuracy (EX), which measures whether the SQL query execution result matches the expected output, and Exact Match (EM), which evaluates whether the generated SQL query exactly matches the reference query in both structure and semantics. The Data Science task is measured using pass@1, which indicates the percentage of correct solutions generated by the large language model on the first attempt.

To train the base model LLM1 of Table 1, the preference-guided code generation system 106 uses a zero-shot prompt containing the question along with reference information (dataset schema for data query and reference code for data science). For different answer collections, the preference-guided code generation system 106 employs the best-of-n strategy by sampling 16 responses at the temperature of 1.0. The preference-guided code generation system 106 trains one epoch per iteration and performs four iterations in total, resulting in models {π₁, π₂, π₃, π₄}.

As shown in Table 1, the preference-guided code generation system 106 performs well when training the base open-source LLM1 for the data query task. As shown, existing open-source LLMs have a significant performance gap in code generation for data queries compared to closed source LLMs. Although supervised fine-tuning helps to bridge this gap—e.g., SFT increases the EX of LLM1 on Spider from 59.3% to 67.9%—there remains a notable difference with the EX of the closed source at LLM 74.4%. Notably, the open-source LLM1 trained by the preference-guided code generation system 106 exceeded the SFT-tuned performance by 16.9% and even outperforms the closed-source LLM with an execution accuracy of 76.6% after only four iterations of training. Additionally, on the more challenging Data Set 2, after three iterations, the preference-guided code generation system 106 significantly improved the EX of the LLM1 from 22.3 to 43.1, achieving performance very close to the closed-source LLM.

As also shown in Table 1, the preference-guided code generation system 106 performs well when training the open-source LLM1 for the data science task. On Data Set 3, open-source models like LLM1 and LLM2 struggle, with significantly lower EM and Pass@1 scores compared to the closed-source LLM. Finetuning provides a minor boost in performance, as seen with LLM1's Pass@1 improving from 28.2% to 30.0%. However, as with the data query task, a large performance gap remains between finetuned open-source LLMs and the closed-source LLM, where the closed-source LLM leads with a Pass@1 score of 49.4%. Nonetheless, preference-guided code generation system 106 demonstrates substantial improvements (from 28.2% to 48.6%), nearly matching the improvement of the closed-source LLM.

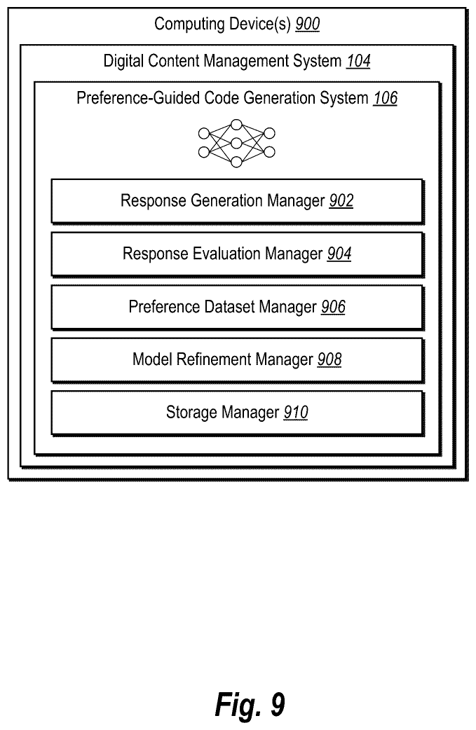

Turning now to FIG. 9, additional detail will now be provided regarding various components and capabilities of the preference-guided code generation system 106. In particular, FIG. 9 illustrates the preference-guided code generation system 106 implemented by the computing device 900 (e.g., the server device(s) 102 and/or one of the client device(s) 110 discussed above with reference to FIG. 1). Additionally, the preference-guided code generation system 106 is also part of the digital content management system 104. As shown in FIG. 9, the preference-guided code generation system 106 includes, but is not limited to, a response generation manager 902, a response evaluation manager 904, a preference dataset manager 906, a model refinement manager 908, and a data storage manager 910.

As just mentioned, and as illustrated in FIG. 9, the preference-guided code generation system 106 includes the response generation manager 902. In one or more embodiments, the response generation manager 902 manages the generation of code responses from a large language model by providing a set of natural language queries from cross-domain sources based on a diverse representation of coding problems and solutions. For example, the response generation manager 902 provides an initial training of set of natural language queries and corresponding ground truth code solutions to a large language model such as a base model open-source large language model trained based on a diverse text corpora to perform natural language processing tasks. By providing the set of natural language queries, the response generation manager 902 prompts the large language model to generate a set of code responses (e.g., executable snippets of code) to perform specific tasks and support a variety of use cases, including data querying (e.g., generating SQL statements for database interaction) and data science workflows (e.g., producing Python code that utilizes libraries such as NumPy for numerical computations or data analysis). At each iteration of training, the response generation manager 902 causes the large language model to generate multiple responses for each of the natural language queries of the training dataset.

As further shown in FIG. 9, the preference-guided code generation system 106 includes the response evaluation manager 904. In one or more embodiments, the response evaluation manager 904 evaluates the set of code responses to determine correct code responses and incorrect code responses. In some cases, the response evaluation manager 904 generates the correct code responses by comparing the executed results of the code responses to ground truth executed results derived from the associated ground truth code response. In some cases, the preference-guided code generation system generates the correct code responses by selecting the executable code responses of the set of code responses. Similarly, the response evaluation manager 904 selects the incorrect code responses that fail to meet the desired functional requirements or objectives of the set of natural language queries. In some cases, the response evaluation manager 904 selects the incorrect code responses by comparing the executed results of the code responses to the ground truth executed results derived from the associated ground truth code response. In some cases, the response evaluation manager 904 selects the incorrect code responses by selecting the non-executable code responses of the set of code responses.

As also shown in FIG. 9, the preference-guided code generation system 106 utilizes the preference dataset manager 906 to generate preference datasets including preference pairs, where each preference pair includes one of the correct code responses randomly matched with one of the incorrect code responses. In certain embodiments, the preference dataset manager 906 generates the preference dataset to contain a specified number of preference pairs. In some cases, if the available number of the correct code responses or the available number of the incorrect code responses are insufficient to meet the required number of preference pairs, the preference dataset manager 906 completes the preference dataset by sampling with replacement from the correct code responses and/or the incorrect code responses.

In one or more embodiments, the preference-guided code generation system 106 utilizes the model refinement manager 908 to refine the large language model utilizing a dual-loss function. For example, the model refinement manager 908 utilizes a dual-loss function that integrates direct preference optimization (DPO) and supervised fine-tuning (SFT) to balance preference-driven optimization with regularization. In some cases, the preference-guided code generation system 106 utilizes the dual-loss function to refine the large language model using direct preference optimization based on the preference dataset and using supervised fine-tuning based on correct code responses. In some cases, the model refinement manager 908 uses the supervised fine-tuning loss to regularize training to prioritize the likelihood of generating correct solutions from the direct preference optimization loss. For example, through the use of a dual-loss function, the model refinement manager 908 improves the likelihood of generating multiple answers for the set of correct code responses.

Additionally, as shown, the preference-guided code generation system 106 includes the data storage manager 910. In particular, the data storage manager 910 (implemented by one or more memory devices) stores natural language queries, large language models, code responses, and dual-loss functions. The data storage manager 910 facilitates the finetuning of the large language models by the preference-guided code generation system 106.

Each of the components 900-910 of the preference-guided code generation system 106 includes software, hardware, or both. For example, the components 900-910 include one or more instructions stored on a computer-readable storage medium and executable by processors of one or more computing devices, such as a client device or server device. When executed by the one or more processors, the computer-executable instructions of the preference-guided code generation system 106 causes the computing device(s) to perform the methods described herein. Alternatively, the components 900-910 include hardware, such as a special-purpose processing device to perform a certain function or group of functions. Alternatively, the components 900-910 of the preference-guided code generation system 106 include a combination of computer-executable instructions and hardware.

Furthermore, the components 900-910 of the preference-guided code generation system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 900-910 of the preference-guided code generation system 106 are implemented as a stand-alone application, such as a desktop or mobile application. Furthermore, in some embodiments, the components 900-910 of the preference-guided code generation system 106 are implemented as one or more web-based applications hosted on a remote server. Alternatively, or additionally, the components 900-910 of the preference-guided code generation system 106 are implemented in a suite of mobile device applications or “apps.” For example, in one or more embodiments, the preference-guided code generation system 106 comprises or operates in connection with digital software applications such as: ADOBE@EXPERIENCE PLATFORM. The foregoing is either registered a trademark or trademarks of Adobe Inc. in the United States and/or other countries.

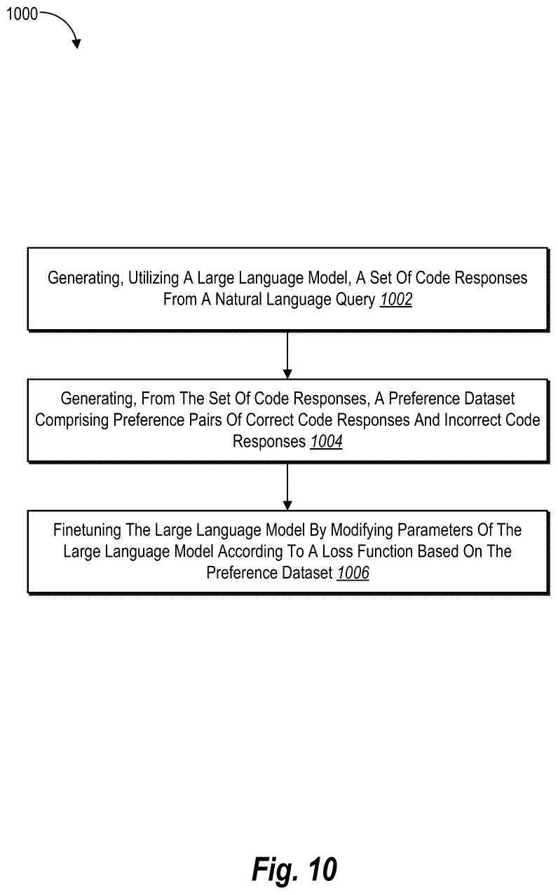

FIGS. 1-10, the corresponding text, and the examples provide a number of different methods, systems, devices, and non-transitory computer-readable media of the preference-guided code generation system 106. In addition to the foregoing, one or more embodiments are also described in terms of flowcharts comprising acts for accomplishing a particular result, as shown in FIG. 10. In some embodiments, the acts shown in FIG. 10 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 10. In some embodiments, a system is configured to perform the acts of FIG. 10. Alternatively, the acts of FIG. 10 are performed as part of a computer-implemented method.

FIG. 10 illustrates a flowchart of a series of acts for finetuning a large language model by modifying parameters based on a preference dataset in accordance with one or more embodiments. While FIG. 10 illustrates acts according to one embodiment, alternative embodiments omit, add to, reorder, and/or modify any acts shown in FIG. 10.

FIG. 10 illustrates an example series of acts 1000 for utilizing a preference-guided code generation system 106 to finetune a large language model using preference-guided optimization. In particular, in certain embodiments, the series of acts 1000 includes an act 1002 of generating, utilizing a large language model, a set of code responses from a natural language query. Specifically, in one or more embodiments, the act 1002 includes generating, utilizing a large language model, a set of code responses from a natural language query, wherein the set of code responses comprise code. In particular, in certain embodiments, the series of acts 1000 includes an act 1004 of generating, from the set of code responses, a preference dataset comprising preference pairs of correct code responses and incorrect code responses. In particular, in one or more embodiments, the act 1004 includes generating, from the set of code responses, a preference dataset comprising preference pairs of correct code responses from a set of correct code responses and incorrect code responses from a set of incorrect code responses in relation to a ground truth code response. As illustrated, in some embodiments, the series of acts 1000 also includes an act 1006 of generating, based on the selection and utilizing a material detection neural network, a first material selection comprising an indication of pixels comprising the material. In particular, in one or more embodiments, the act 1006 includes finetuning the large language model by modifying parameters of the large language model according to a loss function based on the preference dataset. In particular, in one or more embodiments, the act 1006 includes finetuning the large language model by modifying parameters of the large language model to reduce incorrect code responses according to a loss function based on the preference dataset.

In addition (or in the alternative) to the acts described above, in certain embodiments, the preference-guided code generation system series of acts 1000 also includes iteratively finetuning, utilizing the loss function, the large language model based on a plurality of preference datasets generated from a plurality of sets of code responses until a difference for the loss function of consecutive iterations satisfies a convergence threshold. In some embodiments, the series of acts 1000 also includes executing the set of code responses to generate a set of executed results. Moreover, in one or more embodiments, the preference-guided code generation system 106 series of acts 1000 includes determining the set of correct code responses and the set of incorrect code responses by comparing the set of executed results to a ground truth executed result of the ground truth code response.

Further still, in some embodiments, the preference-guided code generation system 106 series of acts 1000 includes determining the set of correct code responses in response to determining that a first subset of the set of executed results matches the ground truth executed result. Furthermore, in one or more embodiments, the preference-guided code generation system series of acts 1000 includes determining the set of incorrect code responses in response to determining that a second subset of the set of executed results differ from the ground truth executed result. Moreover, one or more embodiments, the series of acts 1000 includes randomly sampling from the set of correct code responses and the set of incorrect code responses to generate the preference pairs.

Further still, in one or more embodiments, the series of acts 1000 includes determining that a number of code responses in the set of correct code responses or the set of incorrect code responses is less than a pair threshold for a number of preference pairs to include in the preference dataset. Moreover, in one or more embodiments, the series of acts 1000 includes, in response to the number of code responses being less than the pair threshold, utilizing sampling with replacement to randomly pair the correct code responses with the incorrect code responses to generate the preference pairs. Moreover, one or more embodiments, the series of acts 1000 includes generating the loss function combining a first loss term representing a direct preference optimization loss balanced with a second loss term representing a supervised fine tuning loss. Furthermore, in one or more embodiments, the series of acts 1000 includes determining the first loss term utilizing direct preference optimization to favor correct code responses over incorrect code responses in code responses generated by the large language model based on the preference pairs. Moreover, in one or more embodiments, the series of acts 1000 includes determining the second loss term utilizing supervised fine tuning to increase a likelihood of the large language model generating correct code responses based on the set of correct code responses in the preference pairs.

In one or more embodiments, the series of acts 1000 includes generating, utilizing a large language model, a set of code responses comprising code based on a natural language query. Further still, in one or more embodiments, the series of acts 1000 includes determining a set of correct code responses and a set of incorrect code responses from the set of code responses. In one or more embodiments, the series of acts 1000 further includes generating a preference dataset comprising preference pairs of correct code responses and incorrect code responses by selecting correct code responses from the set of correct code responses and incorrect code responses from the set of incorrect code responses and pairing the selected correct code responses with the selected incorrect code responses. In addition, in one or more embodiments, the series of acts 1000 includes finetuning the large language model by modifying parameters of the large language model to reduce incorrect code responses based on the preference dataset.

Furthermore, in one or more embodiments, the series of acts 1000 includes generate, utilizing the large language model, an additional set of code responses comprising additional code based on an additional natural language query.

In addition, in one or more embodiments, the series of acts 1000 includes generating an additional preference dataset comprising additional preference pairs of additional correct code responses and additional incorrect code responses from the additional set of code responses. Moreover, in one or more embodiments, the series of acts 1000 includes finetuning the large language model by modifying parameters of the large language model to reduce incorrect code responses according to a loss function based on the additional preference dataset. In one or more embodiments, the series of acts 1000 includes selecting, for the set of correct code responses, a first subset of the set of code responses with executed results that match a ground truth executed result of a ground truth code response. Furthermore, in one or more embodiments, the series of acts 1000 includes selecting, for the set of incorrect code responses, a second subset of the set of code responses with executed results that differ from the ground truth executed result of the ground truth code response based on the set of incorrect code responses including syntax errors or execution errors.

In some embodiments, the series of acts 1000 also includes selecting, for the set of correct code responses, a first subset of the set of code responses by selecting executable code responses of the set of code responses. Moreover, in one or more embodiments, the preference-guided code generation system 106 series of acts 1000 includes selecting, for the set of incorrect code responses, a second subset of the set of code responses by selecting non-executable code responses of the set of code responses. Further still, in some embodiments, the preference-guided code generation system 106 series of acts 1000 includes randomly sampling from the set of correct code responses. Furthermore, in one or more embodiments, the preference-guided code generation system series of acts 1000 includes randomly sampling from the set of incorrect code responses. Further still, in one or more embodiments, the series of acts 1000 includes generating a preference pair comprising a randomly sampled correct code response and a randomly sampled incorrect code response.

Moreover, in one or more embodiments, the series of acts 1000 includes determining a number of preference pairs to include in the preference dataset. In certain embodiments, the series of acts 1000 further includes determining that the set of correct code responses or the set of incorrect code responses has fewer code responses than the number of preference pairs. Moreover, one or more embodiments, the series of acts 1000 includes randomly sampling from the set of correct code responses or the set of incorrect code responses using sampling with replacement. Moreover, one or more embodiments, the series of acts 1000 includes generating a dual-loss function comprising a direct preference optimization loss and a supervised fine-tuning loss to increase a probability of generating correct code responses and reducing a probability of generating incorrect code responses.

Furthermore, in one or more embodiments, the series of acts 1000 includes generating the preference dataset comprising a plurality of sets of triplets by generating a first set of triplets comprising the natural language query and the preference pairs. Moreover, in one or more embodiments, the series of acts 1000 includes generating a second set of triplets comprising an additional natural language query and additional preference pairs from an additional set of correct code responses and an additional set of incorrect code responses generated utilizing the large language model based on the additional natural language query.

In one or more embodiments, the series of acts 1000 includes generating, utilizing a large language model, a set of code responses from a natural language query, wherein the set of code responses comprise code. Further still, in one or more embodiments, the series of acts 1000 includes a step for generating a preference dataset comprising pairs of correct code responses and incorrect code responses from the set of code responses. In one or more embodiments, the series of acts 1000 further includes finetuning the large language model by modifying parameters of the large language model to reduce incorrect code responses according to a loss function based on the preference dataset.

In addition, in one or more embodiments, the series of acts 1000 includes iteratively finetuning, utilizing iterative losses determined via the loss function at a plurality of timesteps of the large language model, the large language model based on a plurality of preference datasets generated from a plurality of sets of code responses corresponding to a plurality of natural language queries comprising the natural language query. Furthermore, in one or more embodiments, the series of acts 1000 includes generating the loss function with a first loss term representing a direct preference optimization loss and a second loss term representing a supervised fine tuning loss. Further still, in one or more embodiments, generating a plurality of code responses utilizing the large language model based on a predetermined number of code responses from the natural language query.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 11 illustrates, in block diagram form, an example computing device 1100 (e.g., the computing device 1100, the client device(s) 110, and/or the server device(s) 102) that may be configured to perform one or more of the processes described above. As shown by FIG. 11, the computing device can comprise a processor(s) 1102, memory 1104, a storage device 1106, an I/O interface 1108, and a communication interface 1110.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them. The computing device 1100 includes memory 1104, which is coupled to the processor(s) 1102. The memory 1104 may be used for storing data, metadata, and programs for execution by the processor(s). The memory 1104 may include one or more of volatile and non-volatile memories. The memory 1104 may be internal or distributed memory. The computing device 1100 includes a storage device 1106 includes storage for storing data or instructions. As an example, and not by way of limitation, storage device 1106 can comprise a non-transitory storage medium described above. The computing device 1100 also includes one or more input or output (“I/O”) devices/interfaces 1108, which are provided to allow a user to provide input to (such as user strokes), receive output from, and otherwise transfer data to and from the computing device 1100. These I/O devices/interfaces 1108 may include a mouse, keypad or a keyboard, a touch screen, camera, optical scanner, network interface, modem, other known I/O devices or a combination of such I/O devices/interfaces 1108.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices (e.g., computing device 1100) or one or more networks. The computing device 1100 can further include a bus 1112. The bus 1112 can comprise hardware, software, or both that couples components of computing device 1100 to each other.

What is claimed is:

1. A non-transitory computer readable medium storing executable instructions which, when executed by a processing device, cause the processing device to perform operations comprising:
generating, utilizing a large language model, a set of code responses from a natural language query, wherein the set of code responses comprise code;
generating, from the set of code responses, a preference dataset comprising preference pairs of correct code responses from a set of correct code responses and incorrect code responses from a set of incorrect code responses in relation to a ground truth code response; and
finetuning the large language model by modifying parameters of the large language model to reduce incorrect code responses according to a loss function based on the preference dataset.

2. The non-transitory computer readable medium of claim 1, further comprising iteratively finetuning, utilizing the loss function, the large language model based on a plurality of preference datasets generated from a plurality of sets of code responses until a difference for the loss function of consecutive iterations satisfies a convergence threshold.

3. The non-transitory computer readable medium of claim 1, further comprising:
executing the set of code responses to generate a set of executed results; and
determining the set of correct code responses and the set of incorrect code responses by comparing the set of executed results to a ground truth executed result of the ground truth code response.

4. The non-transitory computer readable medium of claim 3, further comprising:
determining the set of correct code responses in response to determining that a first subset of the set of executed results matches the ground truth executed result; and
determining the set of incorrect code responses in response to determining that a second subset of the set of executed results differ from the ground truth executed result.

5. The non-transitory computer readable medium of claim 1, wherein generating the preference pairs further comprises randomly sampling from the set of correct code responses and the set of incorrect code responses to generate the preference pairs.

6. The non-transitory computer readable medium of claim 1, wherein generating the preference pairs further comprises:
determining that a number of code responses in the set of correct code responses or the set of incorrect code responses is less than a pair threshold for a number of preference pairs to include in the preference dataset; and
in response to the number of code responses being less than the pair threshold, utilizing sampling with replacement to randomly pair the correct code responses with the incorrect code responses to generate the preference pairs.

7. The non-transitory computer readable medium of claim 1, wherein finetuning the large language model further comprises generating the loss function combining a first loss term representing a direct preference optimization loss balanced with a second loss term representing a supervised fine tuning loss.

8. The non-transitory computer readable medium of claim 7, wherein finetuning the large language model further comprises:
determining the first loss term utilizing direct preference optimization to favor correct code responses over incorrect code responses in code responses generated by the large language model based on the preference pairs; and
determining the second loss term utilizing supervised fine tuning to increase a likelihood of the large language model generating correct code responses based on the set of correct code responses in the preference pairs.

9. A system comprising:
one or more memory devices; and
one or more processors configured to cause the system to:
generate, utilizing a large language model, a set of code responses comprising code based on a natural language query;
determine a set of correct code responses and a set of incorrect code responses from the set of code responses;
generate a preference dataset comprising preference pairs of correct code responses and incorrect code responses by:
selecting correct code responses from the set of correct code responses and incorrect code responses from the set of incorrect code responses; and
pairing the selected correct code responses with the selected incorrect code responses; and
finetune the large language model by modifying parameters of the large language model to reduce incorrect code responses based on the preference dataset.

10. The system of claim 9, further comprising wherein the one or more processors are configured to:
generate, utilizing the large language model, an additional set of code responses comprising additional code based on an additional natural language query;
generate an additional preference dataset comprising additional preference pairs of additional correct code responses and additional incorrect code responses from the additional set of code responses; and
finetune the large language model by modifying parameters of the large language model to reduce incorrect code responses according to a loss function based on the additional preference dataset.

11. The system of claim 9, wherein determining the set of correct code responses and the set of incorrect code responses further comprises:
select, for the set of correct code responses, a first subset of the set of code responses with executed results that match a ground truth executed result of a ground truth code response; and
select, for the set of incorrect code responses, a second subset of the set of code responses with executed results that differ from the ground truth executed result of the ground truth code response based on the set of incorrect code responses including syntax errors or execution errors.

12. The system of claim 9, further comprising wherein the one or more processors are configured to:
select, for the set of correct code responses, a first subset of the set of code responses by selecting executable code responses of the set of code responses; and
select, for the set of incorrect code responses, a second subset of the set of code responses by selecting non-executable code responses of the set of code responses.

13. The system of claim 9, wherein the one or more processors are configured to generate the preference dataset by comprising the preference pairs by:
randomly sampling from the set of correct code responses;
randomly sampling from the set of incorrect code responses; and
generating a preference pair comprising a randomly sampled correct code response and a randomly sampled incorrect code response.

14. The system of claim 13, wherein the one or more processors are configured to generate the preference dataset by:
determining a number of preference pairs to include in the preference dataset;
determining that the set of correct code responses or the set of incorrect code responses has fewer code responses than the number of preference pairs; and
randomly sampling from the set of correct code responses or the set of incorrect code responses using sampling with replacement.

15. The system of claim 9, wherein finetuning the large language model further comprises generating a dual-loss function comprising a direct preference optimization loss and a supervised fine-tuning loss to increase a probability of generating correct code responses and reducing a probability of generating incorrect code responses.

16. The system of claim 9, wherein the one or more processors are configured to generate the preference dataset comprising a plurality of sets of triplets by:
generating a first set of triplets comprising the natural language query and the preference pairs; and
generating a second set of triplets comprising an additional natural language query and additional preference pairs from an additional set of correct code responses and an additional set of incorrect code responses generated utilizing the large language model based on the additional natural language query.

17. A computer-implemented method comprising:
generating, utilizing a large language model, a set of code responses from a natural language query, wherein the set of code responses comprise code;
a step for generating a preference dataset comprising pairs of correct code responses and incorrect code responses from the set of code responses; and
finetuning the large language model by modifying parameters of the large language model to reduce incorrect code responses according to a loss function based on the preference dataset.

18. The computer-implemented method of claim 17, further comprising iteratively finetuning, utilizing iterative losses determined via the loss function at a plurality of timesteps of the large language model, the large language model based on a plurality of preference datasets generated from a plurality of sets of code responses corresponding to a plurality of natural language queries comprising the natural language query.

19. The computer-implemented method of claim 17, wherein finetuning the large language model further comprises generating the loss function with a first loss term representing a direct preference optimization loss and a second loss term representing a supervised fine tuning loss.

20. The computer-implemented method of claim 17, wherein generating the set of code responses comprises generating a plurality of code responses utilizing the large language model based on a predetermined number of code responses from the natural language query.
